(19) United States
(12) Patent Application Publication
(10) Pub. No.: US 2024/0367555 A1
(43) Pub. Date: Nov. 7, 2024

(54) OVERHEAD LINE SYSTEM WITH A SKEWED PARALLEL ZONE

(71) Applicant: Siemens Mobility GmbH, München (DE)

(72) Inventor: Gunter Hahn, Hausen (DE)

(21) Appl. No.: 18/573,580

(22) PCT Filed: Mar. 31, 2022
(86) PCT No.: PCT/EP2022/058657

§ 371 Date: Dec. 22, 2023

(30) Foreign Application Priority Data
Jun. 22, 2021 (DE) 10 2021 206 407.8

(51) Int. Cl. B60M 1/22; B60M 1/13; B60M 1/23

(52) U.S. Cl. CPC B60M 1/22; B60M 1/13; B60M 1/23

(57) ABSTRACT

An overhead line system provides electrical energy for an electrically driven vehicle by use of an overhead line. The overhead line system has a plurality of catenary systems which each have a contact wire connected to a carrying cable by a plurality of connecting devices and which are arranged, on the basis of parallel zones, to form a continuously accessible overhead line. The overhead line system further has an overhead line which is arranged in a curvature section in such a way that the vertical projection of the overhead line has a curved profile in a horizontal plane. The overhead line system also has a curved parallel zone which is arranged in the curvature section in such a way that the vertical projection of the parallel zone into the horizontal plane follows the curved profile of the projection of the at least one overhead line in the curvature section.

The invention relates to an overhead line system and a method for erecting the overhead line system.

Overhead line systems serve to provide electrical energy for an electrically driven vehicle. This electrical energy is normally transmitted by means of contact wires to a current collector, in particular a pantograph, of the vehicle. For operation, the contact wires must have a certain mechanical tensile stress. For this reason the contact wires are routed to a guy mast after a length of approximately 1.5 km. To provide a continuously accessible overhead line the individual contact wires are arranged, on the basis of parallel zones, to form a continuously accessible overhead line. The contact wires must run along these parallel zones at predetermined spacings from one another in accordance with strict positioning specifications in order to implement an operationally safe changeover of the contact wires. Besides the electrification of rail-bound vehicles, road vehicles are increasingly being electrified, which requires overhead line systems to be adapted to non-track-bound vehicles. Compared to overhead line systems for track-bound vehicles, stricter positioning specifications apply for such overhead line systems for non-track-bound vehicles. This poses a particular difficulty in adapting an overhead line system to an existing roadway.

The object of the invention is to provide a continuously accessible overhead line that can be adapted to a specified roadway.

This object is achieved by an overhead line system with the features of claim 1.

Furthermore, the invention is also based on the object of specifying a method for the creation of the inventive overhead line system.

This object is achieved by the method with the features of the subordinate method claim.

Advantageous developments of the present invention can in each case be taken from the dependent subclaims.

The inventive overhead line system has multiple catenary systems, which each have a contact wire connected to a carrying cable by means of multiple connection devices and which are arranged, on the basis of parallel zones, to form a continuously accessible overhead line. Furthermore, the inventive overhead line system has at least one overhead line which is arranged in a curvature section, such that the vertical projection thereof has a curved profile in a horizontal plane. Moreover, a curved parallel zone is provided, which is arranged in the curvature section such that the vertical projection thereof in the horizontal plane follows said curved profile of the projection of the at least one overhead line in the curvature section. Illustrated by way of example, the said overhead line system can be arranged along a curved section of a roadway. In this case the said curvature section can be arranged in this curved section such that the at least one overhead line is arranged substantially in parallel to a carriageway of the roadway as well as substantially in parallel to the roadway. In this way it is possible to electrify any curved roadway.

In principle, contact wires of catenary systems arranged in pairs of the multiple catenary systems are changed over in a parallel zone. Catenary systems arranged in pairs on the basis of parallel zones to form a continuously accessible overhead line are referred to below as a catenary system pair. The contact wires of a catenary system pair are normally changed over by raising a contact wire of a first catenary system of the catenary system pair, starting from the level of a profile of the overhead line, and lowering a contact wire of a second catenary system of the catenary system pair to the level of a profile of the overhead line. The contact wires of a catenary system pair have the same polarity in normal operation. In an advantageous embodiment variant the overhead line system is designed to be two-pole, in that it has two overhead lines of different polarity. In this way it is possible to electrify road vehicles without the need for reverse current transmission across a traffic lane.

An advantageous development provides that catenary systems of the multiple catenary systems arranged in the curvature section are designed such that a vertical axis running in one plane and a straight connecting line running in the same plane between the contact wire and the carrying cable of a respective catenary system confine an angle that is ≥9° and ≤70°. The said plane is in this case a plane extending substantially perpendicular to a direction of longitudinal extension of the at least one overhead line. In this way a profile of a contact wire can reliably follow a profile of a traffic lane. The contact wire and the carrying cable of each of the catenary systems arranged in the curved parallel zone are preferably spaced apart from one another in a skewed manner, such that they are spaced apart from one another with a horizontal spacing component.

A further advantageous development provides that the contact wires and carrying cables of a first and of a second catenary system of the multiple catenary systems in an intersection area are arranged such that projections of the contact wire and of the carrying cable of the first catenary system in a horizontal plane intersect projections of the contact wire and of the carrying cable in said horizontal plane. In this case the contact wire and the carrying cable of the first catenary system in the intersection area are in each case arranged above the contact wire and the carrying cable of the second catenary system. This enables a collision between intersecting contact wires and carrying cables to be largely prevented.

Further, an advantageous development provides that each catenary system of the multiple catenary systems has a section, along which multiple directly adjacent connection devices of the respective catenary system are spaced apart from one another such that their connection points to the contact wire along the profile of the contact wire have the same standard spacing from one another. Furthermore, the said sections of the catenary system are arranged in the curvature section such that connection devices of different catenary systems of a catenary system pair have a minimum spacing from one another taken from a value range of between half the value of the standard spacing less 100 cm and half the value of the standard spacing plus 100 cm. The minimum spacing between two connection devices corresponds to the spacing between a point of intersection of an axis with the carrying cable of a first catenary system, wherein this axis, starting from a connection point of a connection device of a second catenary system to an associated carrying cable of the second catenary system, is substantially perpendicular to the profile of the carrying cable of the second catenary system at this connection point of the connection device of the second catenary system, and a connection point, closest to this point of intersection, of a connection device of the first catenary system to the associated carrying cable of the first catenary system. Despite small spacings between the catenary systems of a catenary system pair, this reliably enables collisions of the connection devices with one another to be prevented.

In a further advantageous embodiment variant it is provided that the standard spacing has a value taken from a value range of between 270 cm and 420 cm, preferably from a value range of between 270 cm and 330 cm. In this way it is made possible for strict positioning specifications on a position and spacings of the contact wires and carrying cables from one another in the curved parallel zone to be reliably implemented. Further, in the event of a contact wire breaking, it is possible to prevent a section thereof from colliding with a vehicle that is traveling underneath this contact wire.

Furthermore, an advantageous development provides that connection devices of the catenary systems of different catenary system pairs, which are each arranged on the basis of the curved parallel zone to form a continuously accessible overhead line, have a minimum spacing of 20 cm, preferably of 30 cm, from one another. The said minimum spacing between connection devices of catenary systems of different catenary system pairs is measured as described in connection with the minimum spacing between connection devices of different catenary systems of a catenary system pair. In particular, the minimum spacing of connection devices of the catenary systems of different catenary system pairs is independent of the aforementioned standard spacing. This makes it possible to achieve a high level of operational safety. In the event of a contact wire breaking, a short circuit with contact wires of different polarity can for example be largely prevented.

An advantageous development further provides that a connection device between an accessible contact wire and a carrying cable of a first catenary system of a catenary system pair has a cranked section. This cranked section is here arranged such that in each of its points it has a clear spacing of at least 5 cm from an accessible contact wire of a second catenary system of the said catenary system pair. An accessible contact wire is here understood to mean a contact wire that is arranged on a level with the overhead line, so that electrical energy can be transmitted between this contact wire and a current collector, in particular a pantograph, of a vehicle. In contrast, an inaccessible contact wire is arranged above a level of the continuously accessible overhead line. In the latter case, transmission of electrical energy to a current collector is prevented because of the higher position of the contact wire. On the basis of this development an operationally-related collision between a connection device and an inaccessible contact wire is largely prevented. Furthermore, as a result of this a compact and operationally safe arrangement of the overhead line system is enabled. Alternatively or additionally, it is conceivable for the said cranked section to have a clear spacing of at least 5 cm from an inaccessible contact wire or a carrying cable of one of the multiple catenary systems in each of its points. Further, the cranked connection device is preferably connected to a contact wire, which in comparison to a further contact wire of the same catenary system is arranged on the inside, in other words along a section with greater curvature.

Further, an advantageous development provides that a connection device between a contact wire and a carrying cable of a first catenary system of a catenary system pair has a curved section. This curved section is arranged such that each of its points has a clear spacing of at least 5 cm from a carrying cable of a second catenary system of the said catenary system pair. This makes it possible to adapt the overhead line system to existing roadways in a cost-effective manner. On the basis of this development an operationally-related collision between a connection device and a carrying cable is largely prevented. Alternatively or additionally, it is conceivable for the said curved section to have a clear spacing of at least 5 cm from a contact wire or a carrying cable of one of the multiple catenary systems in each of its points.

A further advantageous development provides that a connection device of the multiple connection devices connects a contact wire and a carrying cable of a catenary system of the multiple catenary systems to one another such that the profile of the connection device, starting from the contact wire through to the carrying cable, follows a straight connecting line between the contact wire and the carrying cable. The fact that the profile of the connection device follows a straight connecting line should in the present connection be understood to mean that a profile of the connection device is free from jumps, bends or curvatures that diverge significantly from the straight connecting line. Slight curvatures, which for example are caused by a material of the connection device or the way in which the connection device is connected to the contact wire or the carrying cable, should nevertheless be regarded as a profile that follows the straight connecting line.

Further, in an advantageous development the overhead line system has a mast system with multiple retaining devices and multiple masts. In this case the contact wires and the carrying cables of the multiple catenary systems are directly connected to at least one of the multiple retaining devices. Furthermore, in the curvature section a contact wire and a carrying cable of one of the multiple catenary systems are connected to one of the multiple retaining devices and a mast of the mast system such that a vertical support point spacing between said contact wire and said carrying cable on said mast is, as a function of a curvature of the curvature section, smaller the larger the curvature of the curvature section.

In an advantageous embodiment variant the support point spacing along a straight section of the overhead line system is approximately 170 cm. If the curvature section is regarded as an arc, the curvature thereof reduces as the associated circle radius reduces. Starting from the said support point spacing along the straight section, the support point spacing in the curvature section has a value taken from a value range of between 60 cm and a maximum of 100 cm with a circle radius of approximately 800 m.

Depending on a curvature of the curvature section and an angle between the respective contact wire and the respective carrying cable of a catenary system of the multiple catenary systems the vertical support point spacing can be varied such that, starting from a smallest value of approximately 60 cm for a radius of curvature of 800 m up to a value of 170 cm for a straight section, this is increased. In this way it is possible for a lateral offset that arises when contact wires of a catenary system are raised or lowered to be kept small in a cost-effective manner.

In an advantageous embodiment variant it is proposed that this vertical support point spacing between the contact wire and the carrying cable at the said mast is a minimum of 60 cm and a maximum of 120 cm. In practice it has been shown that in this way the lateral offset of the contact wires during raising or lowering can be kept small in a cost-effective manner.

An advantageous form of embodiment provides that catenary systems of a catenary system pair are connected to the mast system spaced apart from one another by a retaining spacing by means of different retaining devices of the multiple retaining devices. In this case a connection device of a catenary system of the catenary system pair, which is arranged along a profile of the contact wire of the catenary system in the curvature section directly following the retaining device of the mast system connected to the contact wire, along the profile of the contact wire has a spacing from said retaining device taken from a value range that is not less than the size of the retaining spacing plus 70 cm and is not greater than the size of the retaining spacing plus 220 cm. The retaining space can for example be a value taken from a value range of between 1 m and 10 m. In particular, this said retaining spacing should be considered separately from the standard spacing. A position of the contact wires of the catenary system relative to a roadway can in this way easily be structurally adapted.

A further advantageous form of embodiment provides that masts in the curvature section are arranged such that those masts to which one of the catenary systems of the multiple catenary systems is connected have a mast spacing of between 30 m and 50 m, preferably of between 30 m and 40 m, from one another. In this way the catenary systems in the curvature section can be arranged reliably and operationally safely.

An advantageous development provides that for the purpose of a continuously electrified overhead line between two catenary systems of a catenary system pair a power connection device is provided, which connects an accessible section of a contact wire of a first catenary system of the catenary system pair to an inaccessible section of a contact wire of a second catenary system of the catenary system pair. This is done in that said power connection device is arranged along a section of the carrying cable of the first catenary system and along a section of the carrying cable of the second catenary system such that the power connection device along this respective section has a length that corresponds to a maximum temperature-related change in length of the contact wire of the first or of the second catenary system. Furthermore, this is achieved in that between the carrying cables of the first and of the second catenary system a loop is provided, with a section length which is at least 130 cm, preferably at least 175 cm. A maximum temperature-related change in length should be understood in the present connection as a maximum expected linear expansion of the respective contact wire due to an operating temperature range, a linear expansion coefficient of the contact wire, and a post-tensioning length of the contact wire. The operating temperature range in this case is determined by normally expected ambient temperatures. A post-tensioning length of the contact wire is measured as a length between two guy masts. The linear expansion coefficient is substantially a function of the choice of the material of the contact wire. Thus a collision of the power connection device with components of the catenary system or with vehicles or their current collectors due to a temperature-related change in length of the power connection device can be largely prevented.

An advantageous embodiment variant provides that a power connection device is provided for the purpose of a continuously electrified overhead line between two catenary systems of a catenary system pair. This power connection device connects an accessible section of a carrier wire of a first catenary system of the catenary system pair to an inaccessible section of a contact wire of a second catenary system of the catenary system pair. This is done in that the power connection device, starting from the accessible section of the contact wire along a section of the carrier wire of the first catenary system, is arranged over a length of at least 50 cm, preferably of at least 75 cm. In this case the said length corresponds approximately to a maximum temperature-related change in length of the contact wire of the corresponding catenary system in a temperate climate zone with a contact wire made of copper. The power connection device then has a loop between the carrying cables of the first and second catenary system of the catenary system pair with a section length of the power connection device of at least 130 cm, preferably of at least 165 cm. The power connection device is further arranged along a section of the carrying cable of the second catenary system over a length of at least 50 cm, preferably of at least 75 cm. In this case the said length, as already described above, corresponds approximately to a maximum temperature-related change in length of the contact wire of the corresponding catenary system in a temperate climate zone with a contact wire made of copper. Lastly the power connection wire is routed from the carrying cable of the second catenary system to the inaccessible section of the contact wire of the second catenary system. In this way an electrical connection of the contact wires of a catenary system pair can be implemented in a reliable manner. The operating safety can be further improved by arranging the power connection device starting from a connection device that is connected to the accessible contact wire.

By means of the inventive method the inventive overhead line system can be created.

To this end, multiple catenary systems, each of which has a contact wire connected to a carrying cable by means of multiple connection devices, are arranged on the basis of parallel zones to form a continuously accessible overhead line. Furthermore, at least one overhead line in a curvature section is arranged such that the vertical projection thereof in a horizontal plane has a curved profile. Moreover, in the curvature section at least one curved parallel zone is arranged such that the vertical projection thereof in the horizontal plane in the curvature section follows the said curved profile of the projection, of the at least one overhead line. This enables the creation of a continuously accessible overhead line along a specified roadway.

In an advantageous development of the method the at least one overhead line is positioned above a carriageway such that the contact wires of the multiple catenary systems run substantially in parallel to the center of a traffic lane.

Furthermore, at least one straight parallel zone is provided, the vertical projection of which in the horizontal plane follows a substantially straight profile of a projection, of the at least one overhead line in the horizontal plane. Moreover, a position of contact wires along the curved parallel zone is arranged offset as a function of a curvature of the curvature section relative to a position of contact wires along the straight parallel zone in the transverse horizontal direction. In particular, the said offset is a function of a curvature of the curvature section, such that the offset is selected to be larger the more the curvature section is curved. The curvature section preferably describes an arc. This arc has a curvature that is dependent on an associated circle radius. For example, with the circle radius of approximately 800 m the said offset is at least 5 cm, preferably at least 10 cm. This offset is reduced as the radius of curvature increases. For example, it is conceivable for this offset to be reduced linearly. In this way a lateral position shift of the contact wires, which occurs for example when the contact wires are raised or lowered or during operation, can easily be compensated for. The contact wires are preferably arranged offset in the transverse horizontal direction along the curved parallel zone inward, toward a greater curvature. This has proven effective in meeting the strict positioning requirements for the non-track-bound electrification of road vehicles.

In an advantageous embodiment variant multiple straight parallel zones are provided. In this case the contact wires are arranged offset in the transverse horizontal direction along the curved parallel zone relative to the center of the traffic lane in comparison to the contact wires along all of the multiple straight parallel zones relative to the center of the traffic lane.

The properties, features and advantages of the invention described above and the manner in which they are achieved are explained in greater detail in connection with the figures in the following description of an exemplary embodiment of the invention. Where expedient, the same reference characters are used in the figures for the same elements of the invention or those corresponding to one another. The exemplary embodiment serves to explain the invention and does not restrict the invention to the combinations of features specified therein, not even with regard to functional features. Moreover, all of the features specified in the exemplary embodiment can be viewed in isolation and combined in a suitable manner with the features of any claim.

In the drawings:

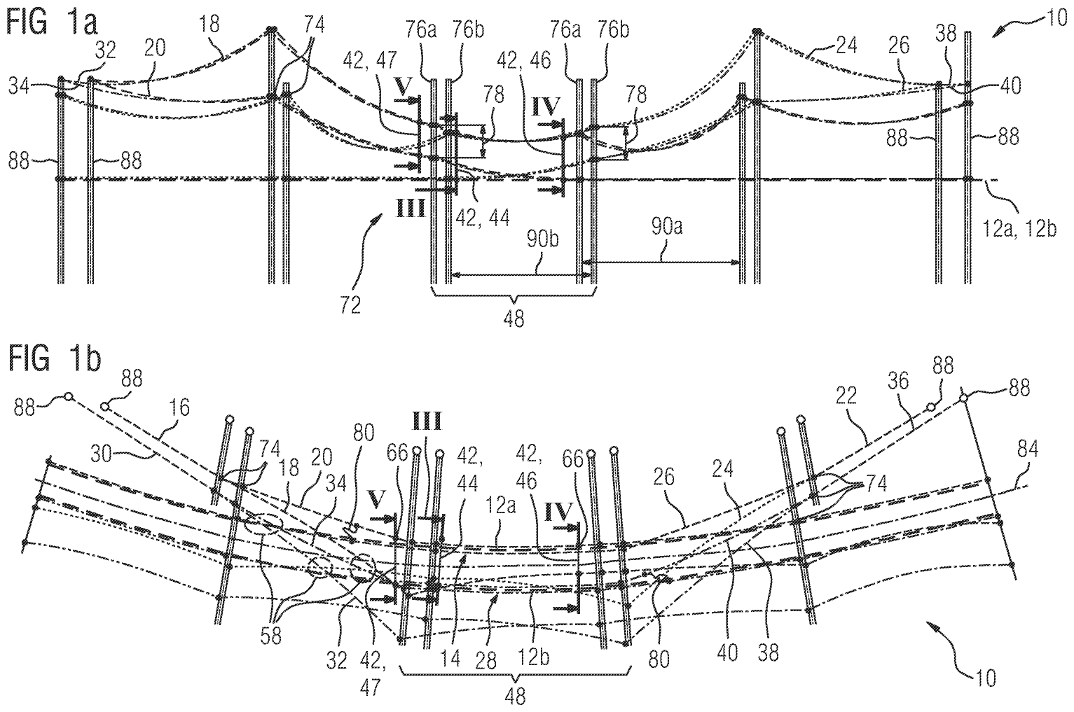

FIG. 1a shows a lateral view of an exemplary embodiment of the inventive overhead line system as a schematic representation and an illustration of an example of the inventive method;

FIG. 1b shows the exemplary embodiment of the overhead line system in a schematic representation as a projection in a horizontal plane and an illustration of the example of the method;

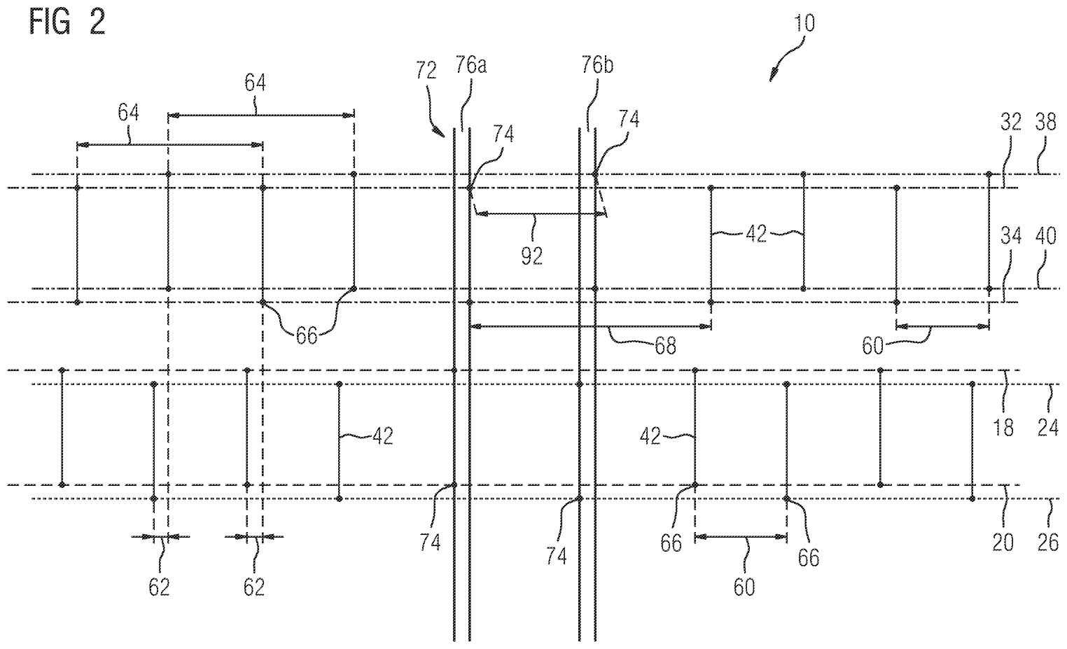

FIG. 2 shows a greatly simplified schematic representation, which by way of example shows an arrangement, not true to scale, of connection devices relative to one another and relative to retaining devices of a mast system;

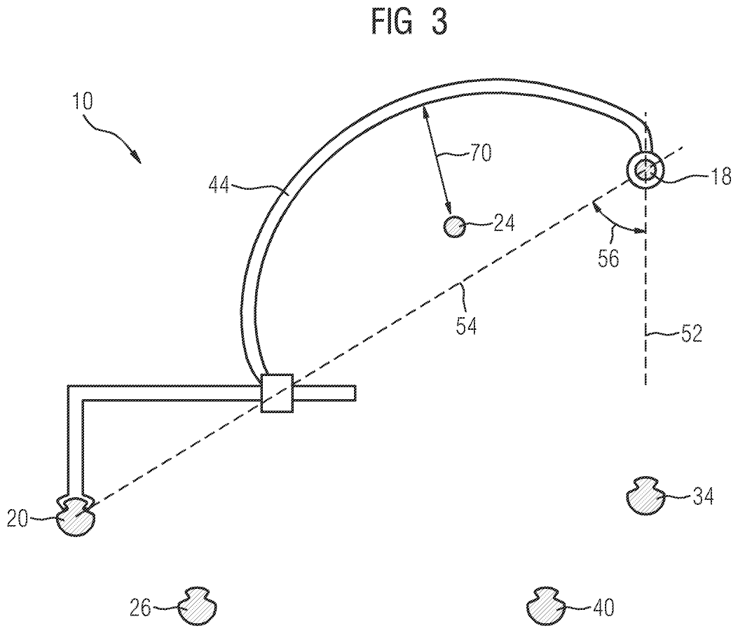

FIG. 3 shows a sectional plane through the overhead line system shown in FIG. 1a and FIG. 1b perpendicular to a direction of longitudinal extension of an overhead line and an example of a curved connection device;

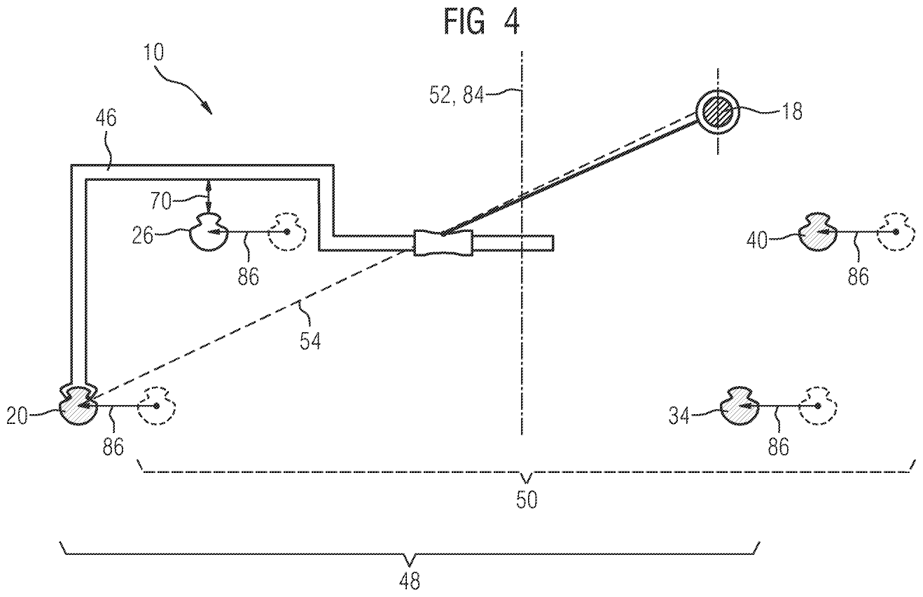

FIG. 4 shows a further sectional plane through the overhead line system perpendicular to a direction of longitudinal extension of an overhead line and an example of a cranked connection device for use with an inclination of between 50° and 70°, supplemented by an exemplary schematic representation of a position of contact wires and associated carrying cables in a section through a straight parallel zone in illustration of the example of the inventive method;

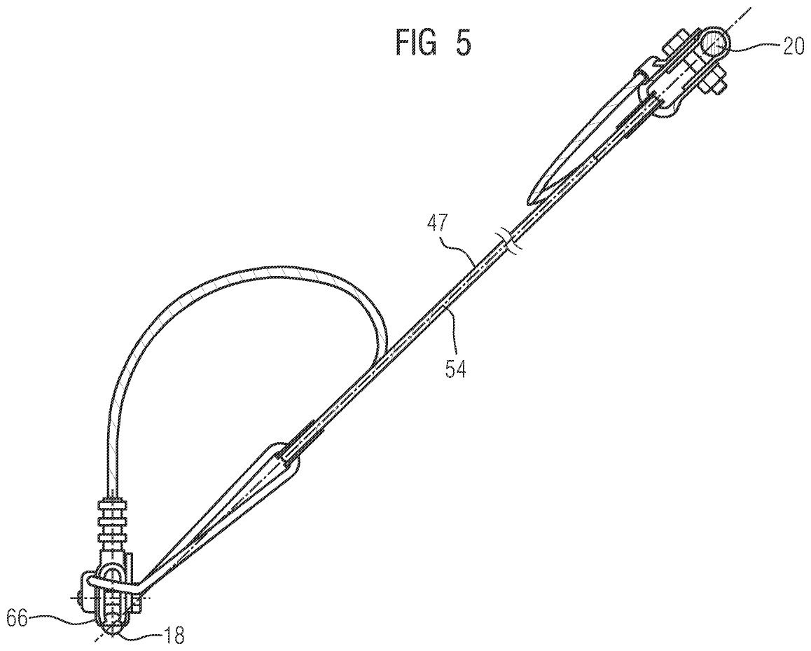

FIG. 5 shows another further sectional plane through the overhead line system shown in FIG. 1a and FIG. 1b perpendicular to a direction of longitudinal extension of an overhead line and an example of a straight connection device;

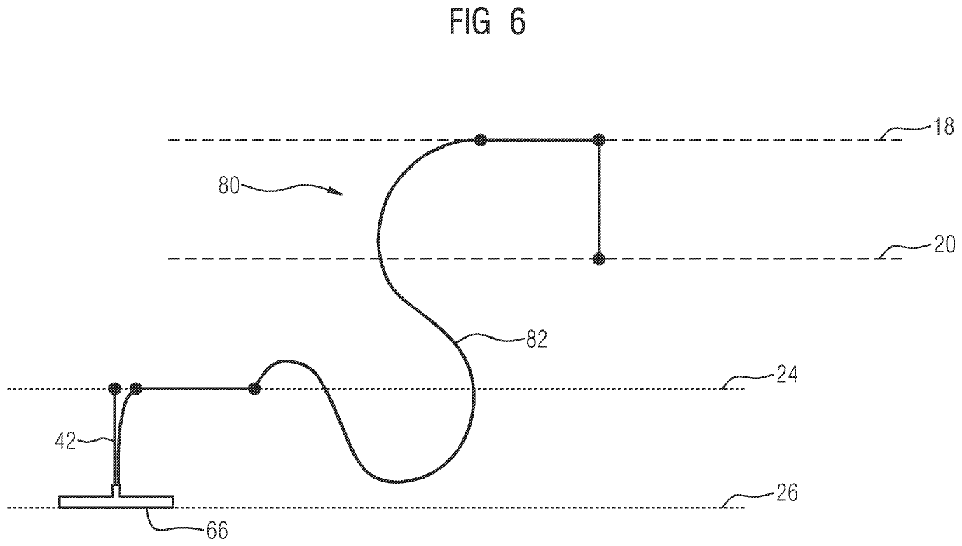

FIG. 6 shows an exemplary embodiment of a power connection device in a schematic representation.

FIG. 1a and FIG. 1b show a curvature section of an overhead line system 10, which is designed to provide electrical energy for an electrically driven vehicle by means of two overhead lines 12a, 12b. In the present exemplary embodiment the overhead line system 10 has two overhead lines 12a, 12b of different polarity. Furthermore, the overhead line system 10 has multiple catenary systems 16, 22, 30, 36, each of which has a contact wire 20, 26, 34, 40 connected to a carrying cable 18, 24, 32, 38 by means of multiple connection devices 42, 44, 46, 47. The multiple catenary systems 16, 22, 30, 36 are arranged on the basis of parallel zones 48, 50 to form a first continuously accessible overhead line 12a and a second continuously accessible overhead line 12b of different polarity. In the present exemplary embodiment the contact wires 20, 26, 34, 40 and carrying cables 18, 24, 32, 38 of each catenary system of the multiple catenary systems 16, 22, 30, 36 of the overhead line system 10 have a specified tensile stress. This is created in that the multiple catenary systems 16, 22, 30, 36 of the overhead line system 10 are routed at regular intervals to what are known as guy masts 88. In the present exemplary embodiment the contact wires 20, 26, 34, 40 and carrying cables 18, 24, 32, 38 have a length of approximately 1.5 km, after which they are guyed. This length is also called the post-tensioning length in expert circles. In order in this case to obtain a continuously accessible overhead line 12a, 12b, the multiple catenary systems 16, 22, 30, 36 of the overhead line system 10 are arranged on the basis of parallel zones 48, 50 to form the first continuously accessible overhead line 12a and the second continuously accessible overhead line 12b. Furthermore, the multiple catenary systems 16, 22, 30, 36 of the overhead line system 10 are suspended on a mast system 72 of the overhead line system 10. The aforementioned guy masts 88 are part of the mast system 72, in addition to further masts 76a, 76b and multiple retaining devices 74. In particular, the parts of the mast system 72 are guy masts 88, masts 76a, 76b and retaining devices 74 already known to a person skilled in the art.

Besides the curvature section of the overhead line system 10 shown in FIG la and FIG. 1b the overhead line system 10 has further sections, not shown in greater detail. FIG. 1a shows a lateral view of the curvature section. In this case it is schematically shown how a first catenary system pair 14 and a second catenary system pair 28 are connected to the mast system 72 by means of the multiple retaining devices 74. FIG. 1b shows a vertical projection of the curvature section in a horizontal plane. In this horizontal plane the first overhead line 12a and the second overhead line 12b have a curved profile. Moreover, FIG. 1b illustrates that in the present exemplary embodiment the two overhead lines 12a, 12b are positioned above a carriageway such that the contact wires 20, 26, 34, 40 of both the aforementioned catenary system pairs 14, 28 in the curvature section run substantially parallel to the center of a traffic lane 84 of a carriageway not shown in greater detail. In the present exemplary embodiment the curved profile of the center of the traffic lane 84 corresponds to an arc, which runs in a radial spacing of approximately 800 m from the center point of the circle. Both the overhead lines 12a, 12b follow the center of the traffic lane 84 in the present exemplary embodiment.

Furthermore, FIG. 1a and FIG. 1b show a curved parallel zone 48. The curved parallel zone 48 is arranged in the curvature section such that the vertical projection thereof in the horizontal plane shown in FIG. 1b corresponds to the said curved profile of the projection of the overhead lines 12a, 12b in said horizontal plane and thus follows the center of the traffic lane 84. Furthermore, FIG. 1b schematically shows that the first catenary system pair 14, consisting of the first catenary system 16 and the second catenary system 22, is arranged on the basis of the curved parallel zone 48 to form the continuously accessible first overhead line 12a. The first catenary system 16 has a first contact wire 20 and a first carrying cable 18. The second catenary system 22 has a second contact wire 26 and a second carrying cable 24. Further, FIG. 1b shows that a second catenary system pair 28 is arranged to form the continuously accessible second overhead line 12b on the basis of the parallel zone 48. The second catenary system pair 28 has a third catenary system 30 and a fourth catenary system 36. The third catenary system 30 has a third contact wire 34 and a third carrying cable 32. The fourth catenary system 36 has a fourth contact wire 40 and a fourth carrying cable 38.

In the present exemplary embodiment the contact wires 20, 34 and carrying cables 18, 32 of the first and of the third catenary system 16, 30 are directly connected to the first type 76a of mast by means in each case of one of the multiple retaining devices 74. Furthermore, the contact wires 26, 40 and carrying cables 24, 38 of the second and fourth catenary system 22, 36 are directly connected to the second type 76b of mast by means in each case of one of the multiple retaining devices 74. By means of the retaining devices 74 the respective contact wires 20, 26, 34, 40 and carrying cables 18, 24, 32, 38 are connected to the corresponding masts 76a, 76b such that a vertical support point spacing 78 between the contact wire 20, 26, 34, 40 and carrying cable 18, 24, 32, 38 of the respective catenary system 16, 22, 30, 36 at the corresponding first type 76a of mast or second type 76b of mast in the case of the arc taken into consideration in the present exemplary embodiment with a circle radius of approximately 800 m has a value of between 60 cm and 80 cm. FIG. 1a further shows that the first type 76a of mast in the present exemplary embodiment has a mast spacing 90a of between 40 m and 50 m from one another. Further, FIG. 1a shows that the second type 76b of mast has a mast spacing 90b of between 40 m and 50 m from one another. The spacings of the directly adjacently arranged first type 76a and second type 76b of mast are in the present exemplary embodiment approximately 2 m. Moreover, a retaining spacing 92 between a retaining device 74, not shown in greater detail, which with the first type 76a of mast and a further retaining device 74, not shown in greater detail, which is connected to the second type 76b of mast spaced apart by 2 m from the first type 76a of mast, is the same size, namely 2 m.

Along the curvature section the catenary systems 16, 22, 30, 36 of both the catenary system pairs 14, 28 are designed such that the respective contact wires 20, 26, 34, 40 and the respective carrying cables 18, 24, 32, 38 are arranged skewed to one another. In this case the contact wire 20, 26, 34, 40 and the carrying cable 18, 24, 32, 38 of the respective catenary systems 16, 22, 30, 36 confine an angle 56, the value of which ranges from ≥9° to ≤70° (see FIG. 3 and FIG. 4). This angle 56 results in a plane that runs perpendicular to a direction of longitudinal extension of the overhead lines 12a, 12b and in which a vertical axis 52 and a straight connection line 54 runs between the respective contact wire 20, 26, 34, 40 and the respective carrying cable 18, 24, 32, 38 of the respective catenary system 16, 22, 30, 36. This angle 56 is shown in an exemplary manner in a schematic representation in FIG. 3, which moreover shows a curved connection device 44 by way of example.

As further shown schematically in FIG. 1b, in the curvature section vertical projections of the contact wires 20, 26, 34, 40 and carrying cables 18, 24, 32, 38 of both the catenary system pairs 14, 28 intersect in the horizontal plane shown in FIG. 1b in each case in intersection areas 58. In the present exemplary embodiment the third contact wire 34, the third carrying cable 32, the second contact wire 26 and the second carrying cable 24 are arranged in intersection areas 58 such that the third carrying cable 32 and the third contact wire 34 are arranged above the second contact wire 26 and the second carrying cable 24. Further, in the present exemplary embodiment the first contact wire 20 and the first carrying cable 18 are arranged in an intersection area 58, in which they intersect the fourth contact wire 40 and the fourth carrying cable 38, above the fourth carrying cable 38 and the fourth contact wire 40.

The multiple connection devices 42, 44, 46, 47 of the catenary systems 16, 22, 30, 36 are already known to the person skilled in the art and for reasons of clarity are merely shown by way of example in FIG. 1a and FIG. 1b. The person skilled in the art is further familiar with such connection devices 42, 44, 46, 47 under the name “hangers”.

FIG. 2 shows by way of example a section from the curvature section shown in FIG. 1a and FIG. 1b in a greatly simplified, schematic representation, in order to explain the arrangement of the multiple connection devices 42, 44, 46, 47 relative to one another and relative to the mast system 72. The multiple connection devices 42, 44, 46, 47 of one of the catenary systems 16, 22, 30, 36 are connected to the contact wire 20, 26, 34, 40 of the respective catenary system 16, 22, 30, 36 such that connection points 66 of directly adjacent connection devices of the multiple connection devices 42, 44, 46, 47 to the respective contact wire 20, 26, 34, 40 have a standard spacing 64 of approximately 300 cm from one another. This standard spacing 64 is implemented along each catenary system 16, 22, 30, 36 in a section that in each case runs between the masts 76a, 76b. Deviating from this, a connection point 66 of a connection device of the multiple connection devices 42, 44, 46, 47 of one of the catenary systems 16, 22, 30, 36, which is arranged along a profile of the associated contact wire 20, 26, 34, 40 directly following a retaining device 74 of the mast system 72, along a profile of the corresponding contact wire 20, 26, 34, 40, has a spacing 68 of 270 cm from this retaining device 74. This spacing 68 results from the retaining spacing 92 plus a value of 70 cm. Furthermore, in the present exemplary embodiment connection devices 42, 44, 46, 47 of different catenary systems 16, 22, 30, 36 of one of the catenary system pairs 14, 28 in the curvature section have a minimum spacing 60 of 130 cm from one another. This minimum spacing 60 results from halving the standard spacing 64 of 300 cm less a value of 20 cm. Moreover, in the present exemplary embodiment connection devices 42, 44, 46, 47 of catenary systems 16, 22, 32, 36 of different catenary system pairs 14, 28 have a minimum spacing 62 of 30 cm from one another.

FIG. 3 schematically represents a curved connection device 44 by way of example of one of the multiple connection devices 42. The curved connection device 44 shown is part of the first catenary system 16 and connects the first carrying cable 18 to the first contact wire 20. The curved connection device 44 has a curved section that in each of its points has a clear spacing 70 of at least 5 cm from the second carrying cable 24. FIG. 3 shows, as already described above, a plane that runs perpendicular to a direction of longitudinal extent of the overhead lines 12a, 12b. In this plane moreover a straight connecting line 54 runs between the first contact wire 20 and the first carrying cable 18 and a vertical axis 52. By way of example, the straight connecting line 54 and the vertical axis 52 confine an angle 56 of approximately 56°.

FIG. 4 shows a further example of the multiple connection devices 42 in the form of a cranked connection device 46. The cranked connection device 46 has a cranked section and connects an accessible section of the first contact wire 20 to the first carrying cable 18. In this case the first contact wire 20 is arranged along the curvature section on the inside. The cranked section of the cranked connection device 46 is in this case arranged such that in each of its points it has a clear spacing 70 of at least 5 cm from an inaccessible section of the second contact wire 26. The inaccessible section of the second contact wire 26 is in this case arranged higher than the accessible section of the first contact wire 20, so that a transfer of electrical energy to a current collector, not shown in greater detail, in particular to a pantograph, not shown in greater detail, is prevented.

Furthermore, FIG. 4 illustrates an arrangement of the contact wires 20, 26, 34, 40 along the curved parallel zone 48 relative to the center of the traffic lane 84. Likewise, the arrangement of contact wires of a straight parallel zone 50 of the overhead line system 10 is shown schematically in FIG. 4 by a dashed line. In contrast to the curved parallel zone 48 a vertical projection of a straight parallel zone 50 in a horizontal plane follows a substantially straight profile of a projection of the overhead lines 12a, 12b in this horizontal plane. On the basis of FIG. 4 it is illustrated that the contact wires 20, 26, 34, 40 along the curved parallel zone 48, which follows an arc with an associated circle radius of approximately 800 m, are in comparison to contact wires along the straight parallel zone 50 relative to the center of the traffic lane 84 arranged offset by approximately 10 cm in the transverse horizontal direction 86.

Further, FIG. 5 schematically represents a further example of one of the multiple connection devices 42 in the form of a straight connection device 47. This straight connection device 47 is provided to be arranged in the curvature section outside the curved parallel zone 48. By way of example, the straight connection device 47 connects the first carrying cable 18 to the first contact wire 20 and in this case follows a straight connecting line 54 between the first contact wire 20 and the first carrying cable 18. By means of the straight connection device 47 shown a space-efficient arrangement is made possible, in which collisions with contact wires 26, 34, 40 or carrying cables 24, 32, 38 of the further catenary systems 22, 30, 36 can be prevented.

FIG. 6 shows by way of example a power connection device 80 of the overhead line system 10, which is designed to produce an electrical connection between contact wires 20, 26, 34, 40 of a catenary system pair 14, 28. Overall in the present exemplary embodiment six power connection devices 80 are provided, two of which are represented schematically by way of example in FIG. 1b. By means of the six power connection devices 80 the contact wires 20, 26, 34, 40 of a catenary system pair 14, 28 are electrically connected to one another, in each case once just upstream and once just downstream of the masts 76a, 76b, between which the curved parallel zone 48 is arranged. Moreover, for the purpose of potential equalization, a power connection device 80 is provided in an intersection area 58 in which contact wires 20, 26, 34, 40 of different catenary system pairs 14, 28 intersect. All power connection devices 80 are substantially based on the same structure, which is explained below by way of example on the basis of the first catenary system pair 14.

In the present exemplary embodiment the power connection device 80 has a flexible electrical conductor. The flexible electrical conductor of the power connection device 80 is, starting from the accessible section of the second contact wire 26, arranged along a section of the second carrying cable 24 over a length of approximately 75 cm along this section. The flexible electrical conductor of the power connection device 80 then has a loop 82 with a section length of approximately 165 cm. Following the loop 82, the flexible electrical conductor of the power connection device 80 is arranged along a section of the first carrying cable 18 over a length of 75 cm along this section. Following the latter section, the first power connection device 80 is then routed to the inaccessible section of the first contact wire 20 and is electrically connected thereto. A length of the section of the electrical conductor of the power connection device 80 along the respective carrying cable 18, 24 corresponds to a maximum temperature-related change in length of a contact wire 20, 26, 34, 40 of a catenary system pair 14, 28. To determine this length, the post-tension length of approximately 1.5 km implemented in the present exemplary embodiment is based on a normal operating temperature range occurring in a Central European climate zone and a contact wire made of copper. Differing post-tension lengths, operating temperature ranges or materials of the contact wire result in a changed maximum temperature-related change in length.

Although the invention has been illustrated and described in greater detail by the preferred exemplary embodiment, the invention is nevertheless not restricted by the disclosed examples and other variations can be derived therefrom by a person skilled in the art, without departing from the scope of protection of the invention.

1-15. (canceled)

16. An overhead line system for providing electrical energy for an electrically driven vehicle, the overhead line system comprising:
overhead lines;
a plurality of catenary systems, each of said catenary systems having a contact wire connected to a carrying cable by means of a plurality of connection devices and said catenary systems are disposed on a basis of parallel zones to form a continuously accessible overhead line;
at least one of said overhead lines is disposed in a curvature section such that a vertical projection thereof in a horizontal plane has a curved profile; and
at least one of said parallel zones is a curved parallel zone, which is disposed in the curvature section such that a vertical projection thereof in the horizontal plane in the curvature section follows the curved profile of the vertical projection of said at least one overhead line.

17. The overhead line system according to claim 16, wherein said catenary systems of said plurality of catenary systems disposed in the curvature section are configured such that a vertical axis running in a plane and a straight connecting line running in the plane between said contact wire and said carrying cable of a respective catenary system confine an angle which is ≥9° and ≤70°, wherein the plane substantially extends perpendicular to a direction of longitudinal extension of said at least one overhead line.

18. The overhead line system according to claim 16, wherein:
a first and a second catenary system of said plurality of catenary systems have contact wires and carrying cables disposed in an intersection area such that projections of said contact wire and of said carrying cable of said first catenary system in a horizontal plane intersect projections of said contact wire and of said carrying cable in the horizontal plane; and
said contact wire and said carrying cable of said first catenary system are disposed in the intersection area in each case above said contact wire and said carrying cable of said second catenary system.

19. The overhead line system according to claim 16, wherein:
each catenary system of said plurality of catenary systems has a section, along which a plurality of directly adjacent said connection devices of a respective catenary system are spaced apart from one another, such that connection points thereof to said contact wire along a profile of said contact wire have a same standard spacing from one another; and
sections of said catenary system are disposed in the curvature section such that said connection devices of different said catenary systems of a catenary system pair, which is disposed on a basis of the curved parallel zone form the continuously accessible overhead line, have a minimum spacing from one another taken from a value range of between half a value of the standard spacing less 100 cm and half the value of the standard spacing plus 100 cm.

20. The overhead line system according to claim 19, wherein the standard spacing (64) has a value taken from a value range of between 270 cm and 420 cm.

21. The overhead line system according to claim 16, wherein said connection devices of a catenary system of different catenary system pairs, which in each case are disposed on a basis of the curved parallel zone to form said continuously accessible overhead line, have a minimum spacing from one another of 20 cm.

22. The overhead line system according to claim 16, wherein a connection device of said connection devices between an accessible said contact wire and said carrying cable of a first catenary system of a catenary system pair of said catenary systems, which on a basis of the curved parallel zone is disposed to form said continuously accessible overhead line, has a cranked section which is disposed such that said cranked section in each of its points has a clear spacing of at least 5 cm from an inaccessible said contact wire of a second catenary system of the said catenary system pair.

23. The overhead line system according to claim 16, wherein a connection device of said connection devices between said contact wire and said carrying cable of a first catenary system of a catenary system pair of said catenary systems, which on a basis of the curved parallel zone is disposed to form said continuously accessible overhead line, has a curved section which is disposed such that the curved section in each of its points has a clear spacing of at least 5 cm from said carrying cable of a second catenary system of said catenary system pair.

24. The overhead line system according to claim 16, wherein a connection device of said plurality of connection devices connects said contact wire and said carrying cable of a catenary system of said plurality of catenary systems to one another such that a profile of said connection device, starting from said contact wire through to said carrying cable, follows a straight connecting line between said contact wire and said carrying cable.

25. The overhead line system according to claim 16,
further comprising a mast system with masts and a plurality of retaining devices, said contact wire and said carrying cable of each of said plurality of catenary systems are directly connected to at least one of said retaining devices; and
wherein said contact wire and said carrying cable of one of said catenary systems in the curvature section are connected to one of said retaining devices and a mast of said masts such that a vertical support point spacing between said contact wire and said carrying cable at said mast is, as a function of a curvature of the curvature section, smaller a greater the curvature of the curvature section.

26. The overhead line system according to claim 25, wherein:
said catenary systems of a catenary system pair, which on a basis of the curved parallel zone is disposed to form said continuously accessible overhead line, are connected, by means of different retaining devices of said retaining devices, to said mast system, spaced apart from one another by a retaining spacing; and
a connection device of said connection devices of a catenary system of said catenary system pair, which is disposed directly following a retaining device of said retaining devices of said mast system connected to said contact wire along a profile of said contact wire of said catenary system in the curvature section, has, along a profile of said contact wire, a spacing from said retaining device taken from a value range that is not less than a size of the retaining spacing plus 70 cm and is not greater than a size of the retaining spacing plus 220 cm.

27. The overhead line system according to claim 25, wherein said masts in the curvature section are disposed such that those said masts to which one of said catenary systems is connected have a mast spacing from one another of between 30 m and 50 m.

28. The overhead line system according to claim 16, further comprising:
a power connection device, wherein for a purpose of a continuously electrified overhead line between two of said catenary systems of a catenary system pair, which on a basis of the curved parallel zone is disposed to form said continuously accessible overhead line, said power connection device is provided, which connects an accessible section of said contact wire of a first catenary system of said catenary system pair to an inaccessible section of said contact wire of a second catenary system of said catenary system pair, in that said power connection device is disposed along a section of said carrying cable of said first catenary system and along a section of said carrying cable of said second catenary system such that said power connection device along a respective said section has a length that corresponds to a maximum temperature-related change in length of said contact wire of said first or of said second catenary system; and
a loop disposed between said carrying cables of said first and of said second catenary system, said loop having a section length of at least 130 cm.

29. The overhead line system according to claim 19, wherein the standard spacing has a value taken from a value range of between 270 cm and 330 cm.

30. The overhead line system according to claim 16, wherein said connection devices of a catenary system of different catenary system pairs, which in each case are disposed on a basis of the curved parallel zone to form said continuously accessible overhead line, have a minimum spacing from one another of 30 cm.

31. The overhead line system according to claim 25, wherein said masts in the curvature section are disposed such that those said masts to which one of said catenary systems is connected have a mast spacing from one another of between 35 m and 40 m.

32. The overhead line system according to claim 28, wherein said section length of said loop is at least 175 cm.

33. A method for creating an overhead line system for provision of electrical energy for an electrically driven vehicle, which method comprises the steps of:
disposing a plurality of catenary systems, each of which has a contact wire connected to a carrying cable by means of a plurality of connection devices, the catenary systems being on a basis of parallel zones to form a continuously accessible overhead line;
disposing at least one overhead line in a curvature section such that a vertical projection of the at least one overhead line in a horizontal plane has a curved profile; and
disposing in the curvature section at least one curved parallel zone such that a vertical projection thereof in the horizontal plane in the curvature section follows the curved profile of the projection of the at least one overhead line.

34. The method according to claim 33, which further comprises:
positioning the at least one overhead line above a carriageway such that contact wires of the catenary systems run substantially in parallel to a center of a traffic lane;
providing at least one straight parallel zone, a vertical projection of which in the horizontal plane follows a substantially straight profile of the vertical projection of the at least one overhead line in the horizontal plane; and
disposing a position of the contact wires along the at least one curved parallel zone offset as a function of a curvature of the curvature section relative to a position of the contact wires along the straight parallel zone in a transverse horizontal direction.
